(19) United States
(12) Patent Application Publication
(10) Pub. No.: US 2012/0105450 A1
(43) Pub. Date: May 3, 2012

(54) Method for estimation of occlusion in a virtual environment

(75) Inventors: Gael Sourimant, Cesson-Sevigne (FR); Pascal Gautron, Cesson-Sevigne (FR); Jean-Eudes Marvie, Cesson-Sevigne (FR)

(73) Assignee: Thomson Licensing

(21) Appl. No.: 13/317,486

(22) Filed: Oct. 19, 2011

(30) Foreign Application Priority Data
Oct. 21, 2010 (FR) 1058604

(51) Int. Cl. G06T 15/40

(52) U.S. Cl. 345/421

(57) ABSTRACT

The invention relates to a method for estimation of the occlusion at a point P of a virtual environment, the point P belonging to a surface (S) grouping at least some of the points of the virtual environment visible from a viewpoint. In order to improve the display while minimising the required calculation time, the method comprises steps for:
estimating intersections between said surface (S) and a plurality of half-lines having as origin said point P, said intersections being estimated by discretization of each half-line of said plurality of half-lines,
associating of occlusion factors with the half-lines of said plurality of half-lines having an intersection with said surface (S), said occlusion factors being a function of occlusion distances Δ₀ separating said point P from said intersections, and
estimation of the occlusion in said point P from said estimated intersections.

### 1. DOMAIN OF THE INVENTION

The invention relates to the domain of synthesis image composition and more specifically to the domain of the estimation of ambient occlusion in a virtual environment. The invention is also understood in the context of special effects for a live composition.

### 2. PRIOR ART

According to the prior art, different methods exist to simulate ambient occlusion in a virtual environment. According to one of these methods, in order to calculate the occlusion in a point of the virtual environment (also called the scene), a sufficient number of rays are launched from this point across the virtual environment in order to determine the intersections between these rays and the geometry neighbouring this point. The relationship between the number of rays intersected and the number of rays launched enables the occlusion at the point being considered to be determined. This method, in order to obtain good quality results, requires a lot of rays to be launched. The resources required to perform the calculations depending directly on the number of rays launched, the requirements in calculations being too great to be carried out live if the desired display quality is high. To carry out the occlusion calculations live, it may be necessary to reduce the number of rays launched, to the detriment of the quality of the display of the virtual environment.

With the emergence of interactive simulation games and applications, notably in three dimensions (3D), the need is being felt for live simulation methods offering a high quality and realistic, rapid global occlusion estimation.

### 3. SUMMARY OF THE INVENTION

The purpose of the invention is to overcome at least one of these disadvantages of the prior art.

More specifically, the purpose of the invention is notably to optimize the calculation time and/or the calculation power required to estimate live the ambient occlusion in a virtual environment to produce a realistic display.

The invention relates to a method for estimation of the occlusion at a point P of a virtual environment, the point P belonging to a surface grouping at least some of the points of the virtual environment visible from a viewpoint, the method comprising steps for:
estimating items of information representative of intersections between the surface and a plurality of half-lines having as origin the point P, the intersections being estimated by discretization of each half-line of the plurality of half-lines, and
associating of occlusion factors with the half-lines of the plurality of half-lines having an intersection with the surface, the occlusion factors being a function of occlusion distances separating the point P from the intersections, and
estimating the occlusion at the point P from information representative of estimated intersections and the occlusion factors.

According to a characteristic, the value of an occlusion factor associated with a half-line of the plurality is inversely proportional to the distance separating the point P from the intersection between the half-line and the surface.

Advantageously, the occlusion at the point P corresponds to the ratio of the number of half-lines having an intersection with the surface (S) to the total number of the plurality of half-lines, the numerator of the ratio representative of the occlusion at the point P being weighted with the occlusion factors.

According to a particular characteristic, the method comprises in addition a step of estimation of distances separating the view point from visible points of the virtual environment, the estimated distances being represented in a depth map, the estimation of items of information representative of intersections being carried out in the space of the depth map.

Advantageously, the plurality of half-lines form a half-sphere centred on P rising mainly above an element of the surface associated with the point P.

According to a specific characteristic, the base of the half-sphere is tangent to the element of the surface associated with the point P.

Advantageously, the method comprises a step of storage of an item of information representative to the occlusion at the point P in an occlusion map.

According to a particular characteristic, the direction of half-lines depends on the location of the point P.

According to another characteristic, the information representative of intersections is estimated using the ray sampling method.

The invention also relates to a device adapted for the estimation of the occlusion at a point P of a virtual environment, the point P belonging to a surface grouping at least some of the points of the virtual environment visible from a viewpoint, the device comprising:
means for the estimation of information representative of intersections between the surface and a plurality of half-lines having as origin the point P, the intersections being estimated by discretization of each half-line of the plurality of half-lines, and
means for the association of occlusion factors with the half-lines of the plurality of half-lines having an intersection with the surface, the occlusion factors being a function of occlusion distances Δ₀ separating the point P from the intersections, and
means for the estimation of occlusion at the point P from the information representative of intersections estimated and the occlusion factors.

According to a characteristic, the value of an occlusion factor associated with a half-line of the plurality is inversely proportional to the distance separating the point P from the intersection between the half-line and the surface.

Advantageously, the occlusion in the point P corresponds to the ratio of the number of half-lines having an intersection with the surface to the total number of the plurality of half-lines, the numerator of the ratio representative of the occlusion at the point P being weighted with the occlusion factors.

### 4. LIST OF FIGURES

The invention will be better understood, and other specific features and advantages will emerge upon reading the following description, the description making reference to the annexed drawings wherein:

FIG. 1A diagrammatically shows a virtual environment as seen from a viewpoint, according to a particular embodiment of the invention,

FIG. 1B shows a depth map, associated with the virtual environment and with the view point, representative of a surface grouping the visible points of FIG. 1A from the viewpoint, according to a particular embodiment of the invention,

FIGS. 2 and 3 diagrammatically show half-spheres formed of directions for which are estimated the intersections with the surface of visible points of the virtual environment of FIG. 1A, according to two particular embodiments of the invention,

FIGS. 4 and 5 diagrammatically show a method for estimation of the intersection between a direction of FIGS. 2 and 3 and the surface of visible points of the virtual environment of FIG. 1A, according to a particular embodiment of the invention,

FIG. 6 shows a device implementing a method for estimation of the occlusion at a point in the virtual environment of FIG. 1A, according to a particular implementation of the invention,

FIG. 7 shows a method for estimation of the occlusion at a point in the virtual environment of FIG. 1A, according to a particular implementation of the invention,

### 5. DETAILED DESCRIPTION OF EMBODIMENTS OF THE INVENTION

The invention will be described in reference to a particular embodiment of a method for estimation of occlusion at a point P of a virtual environment. The point P advantageously is part of a surface formed from all or some of the virtual environment points that are visible from a viewpoint. In order to determine the occlusion at the point P, a plurality of rays having as an origin the point P is launched across the virtual environment and the intersections between each of these rays and the surface of visible points are determined by discretizing launched rays. The occlusion at the point P corresponds for example to the relationship between the number of rays having an intersection with the surface of visible points to the total number of rays. The discretization of each of the rays launched enables the intersection point with the surface to be determined with precision when it exists. As the occlusion at a point, or otherwise known as the shading at a point, depends on the neighbouring geometry of this point, determining with precision the intersections with the surface of visible points surrounding the point P considered enables the occlusion at the point P to be estimated more precisely without however requiring the launch of a great number of rays. Thus, the estimation of the occlusion at the point P according to the specific embodiment of the invention described is rapid and offers a good level of quality, specifically enabling real time or live application.

By estimating the occlusion at each point of the surface of visible points, it is possible to determine the ambient occlusion of the virtual environment and thus to determine a shading at each visible point of the virtual environment, without needing to know the lighting applied to the virtual environment.

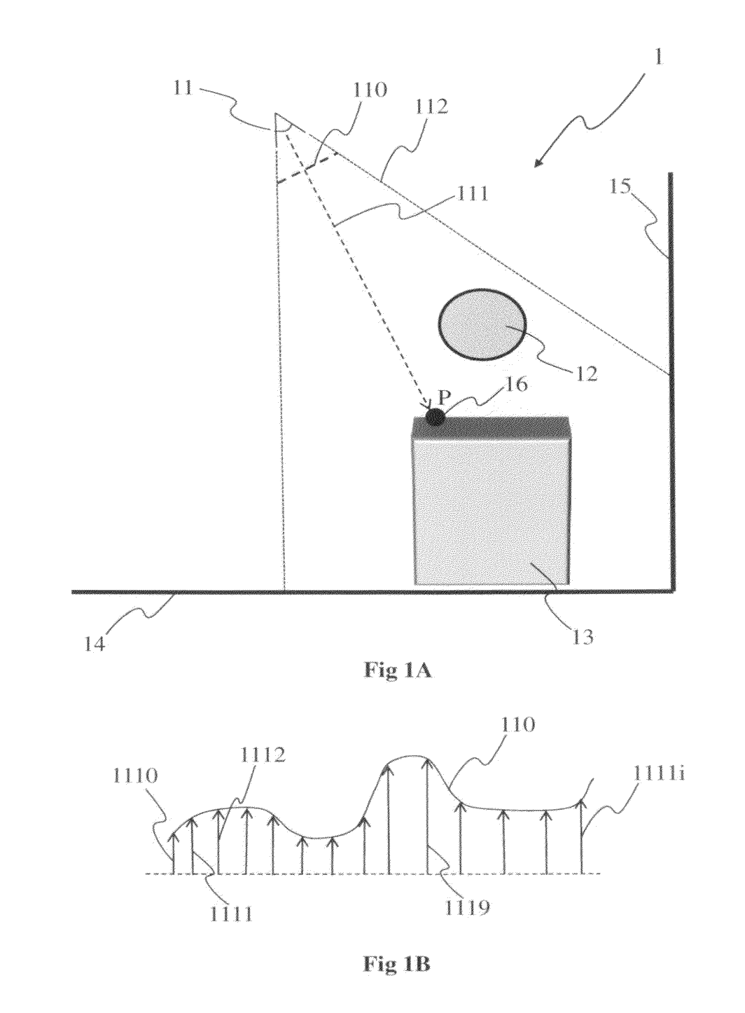

FIG. 1 shows a virtual environment or a virtual scene 1 as seen from a viewpoint 11, for example a spectator of the virtual environment 1. The virtual environment is advantageously lit by a light environment ensuring a constant and homogenous lighting at every point of the virtual environment. The virtual environment 1 comprises one or several virtual objects 12, 13, 14 and 15, modelled according to any method known to those skilled in the art, for example by polygonal modelling, in which the model is assimilated with a set of polygons each defined by the list of summits and edges that compose it, by NURBS (Non uniform rational basic spline) type curve modelling in which the model is defined by a set of curves created via control vertices, by modelling by subdivision of surfaces. By virtual object is understood any virtual representation (obtained by modelling) of an object (real or fictitious) composing a real environment (for example the ground, a house or a house front, a car, a tree, that is to say any element composing an environment such as a part of a house, a street, a town, the countryside, etc.) or an imaginary element. Each object 12, 13, 14 and 15 of the virtual environment is characterized by a surface covering it, the surface of each object having reflectance properties (corresponding to the proportion of incident light reflected by the surface in one or several directions) that are specific to it. Advantageously, the reflectance of the surface of an object varies according to the zone of the object reflecting the light (a zone of the surface comprising one or several points of the surface) that is to say that the reflectance of the surface of an object is not constant. According to a variant, the reflectance of the surface of an object is constant at any point of the surface of the object. According to the example of FIG. 1, the spectator 11 looks at the point P 16 of the virtual environment 1 according to an observation direction 111, the point P 16 corresponding to the intersection between the observation direction 111 and the first object of the virtual environment 1 encountered by this observation direction having as origin the viewpoint 11, namely the object 13. The part of the virtual environment 1 seen from the viewpoint 11 is shown by a viewing cone 112, the viewing cone being composed of a great number of viewing directions including the viewing direction 111. The set of points of objects 12 to 15 visible from the viewpoint 11 advantageously forms a surface S of visible points. According to a variant, the surface S only comprises a sub-set of the set of visible points, for example the visible points of objects 12 and 13 if there is only interest in these objects 12 and 13. Determining the occlusion at the point P 16 means determining the distance separating the point P from each of the points of the surface S in the area neighbouring the point P 16, or in other words, determining the intersections between the half-lines having as origin the point P and the surface S. By neighbouring area of the point P on the surface S is understood for example the set of points belonging to the surface S located at a distance from the point P less than a threshold value, for example at a distance less than 25 cm, 50 cm or 1 m. Advantageously, the determination of intersections between the half-lines with origin at the point P 16 and the surface S is carried out in a world space, that is to say in a space of the virtual environment from geometric coordinates of points considered. The set of half-lines having as origin the point P forms for example a sphere with a centre P, a half-sphere for which the base is centred on P or a quarter-sphere.

According to a variant, the determination of intersections between the half-lines with origin at the point P 16 and the surface S is carried out in a space of a depth map 110. According to this variant, the virtual environment 1 is displayed as seen from the viewpoint 11. Information representative of the virtual environment 1 as seen from the viewpoint 11 is stored in a depth map 110. The depth map advantageously comprises for each point of the virtual environment 1 visible from the viewpoint an item of information representative of the distance separating the viewpoint 11 of the visible point considered. FIG. 1B shows such a depth map 110 according to a particular embodiment of the invention. The information representative of the distance is represented by a vector 1110 to 111i of which the norm is equal to the distance between the view point 11 and the visible point considered. The depth map is thus composed of a plurality of points associated with the visible points of the virtual environment 1 projected onto a surface formed for example by a cone 112 representative of the field of vision of the viewpoint 11 and perpendicular to the main direction of observation of the viewpoint 11. An item of information representative of the depth, that is to say of the distance viewpoint/visible point, is associated with each corresponding point of the depth map. By connecting each point of the depth map formed by the end of vectors representative of the depth, a surface S′ is obtained representative of the set of visible points of the environment as seen from the viewpoint 11. This surface S′ is, like the surface S, representative of the set of all or some of the points of the environment visible from the viewpoint, comprising the point P 43. According to this variant, the depth information is advantageously recorded and stored in a data structure composed of tables recorded in a memory associated with the GPUs. These recordings are called depth recordings. These recordings enable the set of points of the virtual environment 1 visible from the viewpoint 11 to be referenced, for which there can be an occlusion estimation method in order to for example determine the ambient occlusion of the virtual environment 1, or a part of the virtual environment, for example one of several objects 12 to 15 composing the virtual environment 1.

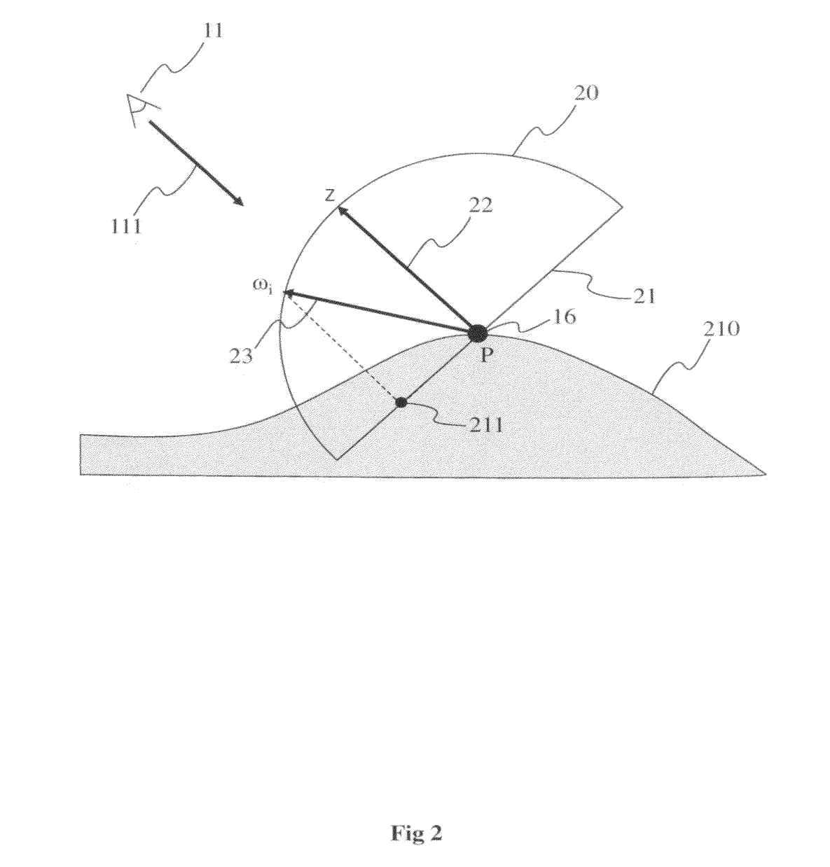

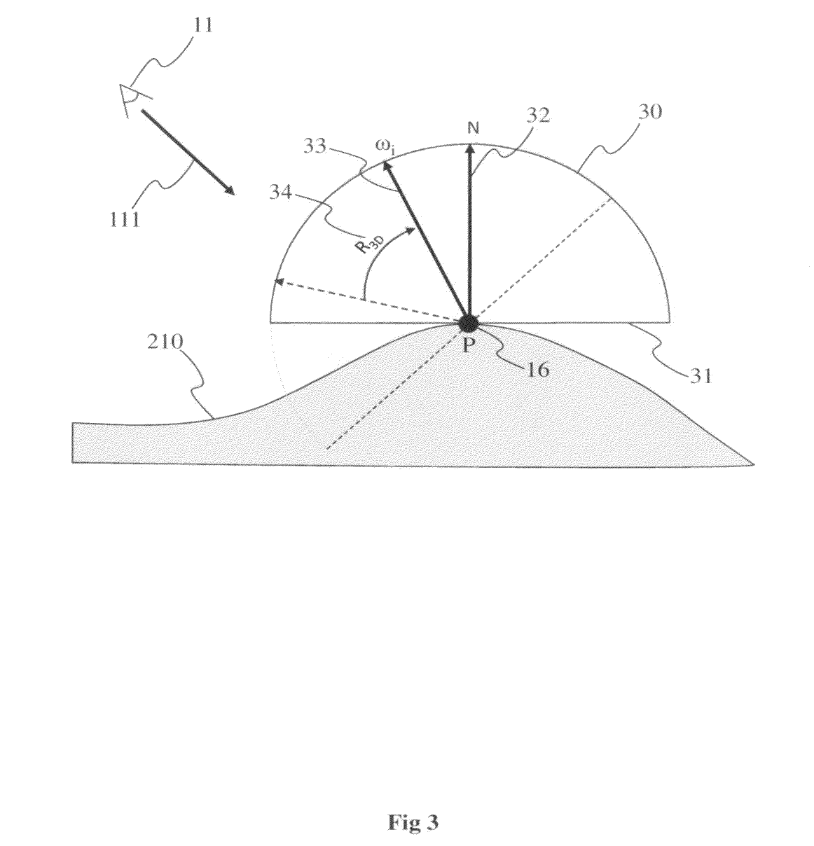

FIGS. 2 and 3 show half-spheres 20 and 30 each formed of half-lines having as origin the point P 16 and for which the intersections with the surface S (or S′ if placed in the space of the depth map) are determined. As shown with respect to FIG. 2, the half-sphere 20 is composed of a plurality of vectors 22, 23, each vector representing the direction associated with a half-line having as origin the point P. The half-sphere 20 has a base 21 that is essentially orthogonal in the observation direction 111 of the virtual environment. In order to determine the vectors 22, 23 that form the half-sphere 20, the base 21 is for example sampled in n samples (each sample corresponding for example to a point 211 or to a surface element associated with the point), each sample of the base 21 being then projected onto the half-sphere 20 according to an orthogonal axis Z at the base 21 to form a vector 23 having as ends the point P on one hand and the projection of the sample considered 211 of the base 21 on the other hand. The number n of samples is advantageously configured by a user. To accelerate the calculations, the number n of samples is advantageously low. To avoid display errors related to under-sampling, the n samples used to represent a half-sphere associated with a point P vary from one point P to another in a given zone of the surface S, a rotation matrix being applied to n base samples to obtain sets of n different samples for each point P of the zone of the surface S considered. To do this, the angle θ of the rotation matrix varies randomly or in a determined manner from one point P to another enabling for each point P to create a set of n samples from the n base samples. The rotation matrix with two dimensions R_{2D} applied to n base samples is equal to for example:

$${R}_{2 D} = [ \begin{matrix}cos θ & - sin θ \\ sin θ & cos θ\end{matrix} ] \qquad ( 1 )$$

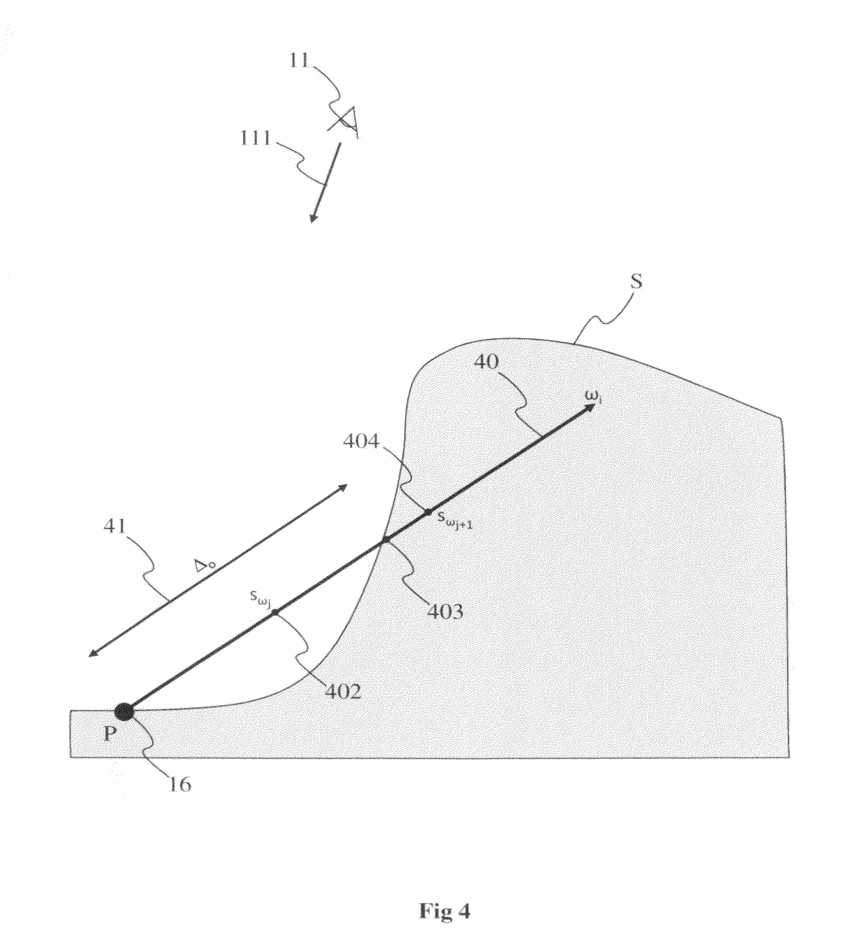

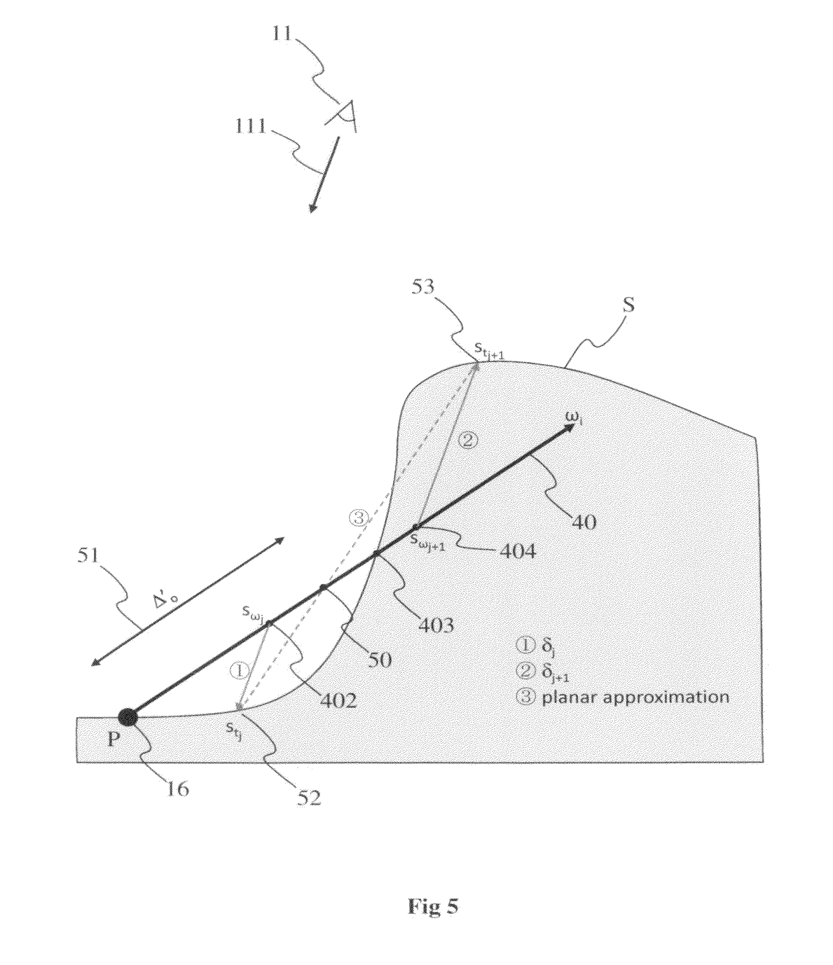

All of the vectors 22, 23 have a common first end, namely the point P 16, a surface element being associated with the second end of each vector 22, 23, the sum of surface elements associated with the vectors forming the surface of the half-sphere 20. To obtain the occlusion at the point P 16, the half-lines having as origin the point P having an intersection with the surface S (as explained more precisely with respect to FIGS. 4 and 5) are first determined and the surface elements associated with the vectors corresponding to these half-lines are then added-up. Then the ratio between on one hand the sum of surface elements corresponding to the half-lines having an intersection with the surface S 110 and on the other hand the total surface of the half-sphere 20 is carried out. The surface ratio thus obtained is representative of the occlusion at the point P 16, this occlusion being representative of the shading on the surface S at the point P. The half-sphere 20 formed from the plurality of half-lines having as origin the point P 16 is advantageously mainly over the surface element 210 of the surface S associated with the point P 16. It is understood by the expression “is mainly over the surface element associated with the point P” the fact that the majority of vectors forming the half-sphere do not have an intersection with the surface element 210 or by the fact that the base 21 of the half-sphere forms an angle with the tangent to the surface element at the point P less than a given threshold value, for example less than 45 degrees.

FIG. 3 also shows a half-sphere for which the base 31 is centred on the point P 16. The half-sphere 30 is composed of a plurality of vectors 32, 33, each vector representing the direction associated with a half-line having as origin the point P for which the intersection with the surface S must be determined. As shown in FIG. 2, the base of the half-sphere 30 is tangent to the surface element 210 of the surface S associated with the point P 16, the vector N representing the normal to the tangent at the surface element 210. The half-sphere 30 for which the base 31 is tangent to the surface element 210 associated with the point P is obtained for example from the half-sphere 20 for which the base 21 is orthogonal to the observation direction 111 turning the axis Z in such a way that it becomes orthogonal to the tangent at the surface element 210. The rotation used in this case corresponds for example to a rotation leading to a sample direction ωᵢ from the space corresponding to the environment 1 as seen from the viewpoint 11 according to the observation direction 111 in the space normal to the tangent at the surface element 210, the rotation being expressed with coordinates of the space corresponding to the environment as seen from the viewpoint 11, this rotation being called R_{3D}. Analytically R_{3D} is determined using an angle/axis representation (r,θ), r being defined as the vector orthogonal to N 32 and Z 22, and θ being defined as being the angle between:

$$\{ \begin{matrix}r = ‖ {[ 0 \; 0 \; 1 ]}^{T} \times N ‖ = ‖ {[ - {N}_{y} {N}_{x} 0 ]}^{T} ‖ \\ cos θ = {[ 0 \; 0 \; 1 ]}^{T} \cdot N = {N}_{z}\end{matrix} \qquad ( 2 )$$

where ∥V∥ represents the normalization operator of a vector V.

By applying the Rodrigue formula of a three-dimensional axis/angle rotation at (2), is obtained:

$${R}_{3 D} = {I}_{3} cos θ + {I}_{3} ( 1 - cos θ ) r \cdot {r}^{T} + [ r ] \times sin θ \\ {R}_{3 D} = {[ \begin{matrix}{N}_{z} + η {N}_{y}^{2} & - η {N}_{x} {N}_{y} & {N}_{x} \\ - η {N}_{x} {N}_{y} & {N}_{z} + η {N}_{x}^{2} & {N}_{y} \\ - {N}_{x} & - {N}_{y} & {N}_{z}\end{matrix} ]}_{avec} η = \frac{1 - {N}_{z}}{{N}_{x}^{2} + {N}_{y}^{2}} \qquad ( 3 )$$

This rotation matrix is calculated once per sample 211 and is applied to each vector to give the direction ωᵢ orientated according to the normal N.

FIGS. 4 and 5 show a method for determination of an intersection between on one hand a half-line 40 of direction ωᵢ having as origin the point P 16 and on the other hand the surface S, according to a particular embodiment of the invention.

As shown with respect to FIG. 4, the half-line 40 having as origin the point P 16 and for direction ωᵢ is discretized into a plurality of elementary samples, each sample corresponding to a segment of the half-line 40. Two samples are shown in FIG. 4, namely the segments [P-S_{ωi}] and [S_{ωi}-S_{ωi+1}]. The half-line 40 is thus represented by several points, namely the points P 16, S_{ωi} 402 and S_{ωi+1} 404. The purpose of such a method is to determine the occlusion distance Δ₀ 41 that corresponds to the distance separating the point P 16 from the intersection point 403 between the half-line 40 and the surface S. To determine if a sample, that is to say a segment of the half-line 40, has an intersection with the surface S, the first point S_{ωi} 402 of the half-line 470 corresponding to the first sample is projected onto the surface S according to the observation direction 111, as shown with respect to FIG. 5. The projection of the point S_{ωi} 402 onto the surface S is a point Sₜⱼ 52, the distance δⱼ separating the points S_{ωi} 402 and Sₜⱼ 52 being recorded, for example in a recording table in a memory associated with the GPUs. To determine if the first segment [P-S_{ωi}] of the half-line 40 has an intersection with the surface S, it suffices to compare the positions of points S_{ωi} 402 and Sₜⱼ 52 with the position of the viewpoint 11. If the point S_{ωi} 402 is closer to the viewpoint 11 than the point Sₜⱼ 52 the length of the observation direction 111, then the first segment [P-S_{ωi}] of the half-line 40 has no intersection with the surface S. In the contrary case, that is to say if the point Sₜⱼ 52 is closer to the viewpoint 11 than the point S_{ωi} 402, then the first segment [P-S_{ωi}] of the half-line 40 has an intersection with the surface S. In the case where the first segment [P-S_{ωi}] of the half-line 40 has an intersection with the surface S, the discretization process of the half-line is stopped as the intersection point of the half-line 40 with the surface S has been determined. In the contrary case shown with respect to FIGS. 4 and 5, that is to say when the first segment [P-S_{ωi}] of the half-line 40 does not have an intersection with the surface S, the discretization process of the half-line 40 continues and continues to the next segment [S_{ωi}-S_{ωi+1}] moving away from the point P 16 in the direction P→ωᵢ. The point S_{ωi+1} 404 is projected onto the surface S according to the observation direction 111, the result of the projection being a point S_{ωi+1} 404 and the distance δⱼ₊₁ separating the points S_{ωi+1} 404 and S_{ωi+1} 404 being recorded, for example in a recording table in a memory associated with the GPUs. To determine if the second segment [S_{ωi}-S_{ωi+1}] of the half-line 40 has an intersection with the surface S, the positions of points S_{ωi+1} 404 and Sₜⱼ₊₁ 53 are compared to the position of the viewpoint 11. The point Sₜⱼ₊₁ 53 being closer to the viewpoint 11 than the point 404, this means that the second segment [S_{ωi}-S_{ωi+1}] has an intersection with the surface S. To precisely determine the position of the intersection point, the second segment [S_{ωi}-S_{ωi+1}] is discretized in turn into a plurality of samples of small size and each point of the segment [S_{ωi}-S_{ωi+1}] representative of the discretization of the second segment is projected onto the surface S according to the direction 111, starting with the point closest to S_{ωi} 402. It is thus possible by reiterating discretization operations of segments of the half-line 40 to estimate with great precision the position of the intersection between a half-line 40 and the surface S. From coordinates of the point P 16 and the estimated intersection point, the occlusion distance Δ₀ is determined. If the successive discretizations into smaller and smaller samples of the half-line 40 enable the intersection with the surface S to be estimated with precision, the necessary calculations can be costly. Advantageously, if no intersection with the surface S has been determined at the n^{th} sample of the half-line, n being greater than a predetermined threshold value (for example equal to 15, 20, 25 or 50 samples), it is considered that the half-line 40 does not have an intersection with the surface S.

According to a variant, the occlusion distance Δ′₀ between the point P and the intersection point between the half-line 40 and the surface S is determined by approximation from the points S_{ωi} 402 and S_{ωi+i} 404 surrounding the intersection point and from distances δⱼ and δⱼ₊₁ previously estimated. According to this variant, it is assumed that the surface element of the surface S comprised between two points representative of the sampling of the half-line 40, for example the points S_{ωi} 402 et S_{ωi+1} 404, is globally plane. In this way, the occlusion distance Δ′₀ is interpolated linearly:

$${Δ}_{0}^{′} = ‖ {S}_{ω j} ‖ + \frac{{δ}_{j} ( ‖ {S}_{ω j + 1} ‖ - ‖ {S}_{ω j} ‖ )}{{δ}_{j} + {δ}_{j + 1}} \qquad ( 4 )$$

To determine an occlusion factor at the point P 16 comprised between 0 and 1, the square root of the occlusion distance Δ′₀ is added to the contribution of the current occlusion at the point P, which is finally adapted to the number of samples. An occlusion factor A(P) at the point P is thus obtained as follows:

$$A ( P ) = {( \frac{1}{n} {\sum }_{i} {V}_{P , ω i} \cdot {Δ}_{0 i}^{′} )}^{α} \qquad ( 5 )$$

Where n corresponds to the number of half-lines,
V_{P, ωi} corresponds to a factor equal to 0 if the half-line considered does not have an intersection with the surface S and equal to 1 if the half-line considered has an intersection with the surface S, and
α corresponds to a predetermined contrast factor, for example configured by a user.

It should be noted that a value of the occlusion factor A(P) close to 0 signifies that the occlusion at the point P is high and that conversely a value of the occlusion factor A(P° close to 1 signifies that the occlusion at the point P is low. Such an occlusion factor advantageously enables the contribution of each half-line having an intersection with the surface S to be weighted in the calculation of the occlusion at the point P. As described with respect to FIGS. 2 and 3, a surface element of a half-sphere formed from a plurality of half-lines having as origin the point P is associated with each half-line forming the half-sphere. To determine the occlusion at the point P, the ratio between on one hand the sum of surface elements corresponding to the half-lines having an intersection with the surface S and on the other hand the total surface of the half-sphere is carried out, the ratio of surface thus obtained being representative of the occlusion at the point P. The contribution of each half-line 40 being an intersection with the surface S in the global occlusion at the point P depends on the distance separating the point P from the intersection. In fact, the more the occlusion distance is increased the less is the contribution of this intersection in the global occlusion at the point P. That is to say that the more the occlusion factor associated with a half-line 40 is close to 1, the less the contribution of the half-line considered in the calculation of global occlusion at the point P is significant. It is thus advantageous to weight each surface element associated with the half-lines having an intersection with the surface S by the occlusion factor before calculating the sum of surface elements associated with half-lines having an intersection with the surface S. The global occlusion at the point P thus corresponds to the ratio of the sum of surface elements, weighted with associated factors A(P), associated with the half-lines having an intersection with the surface S over the total surface of the half-sphere.

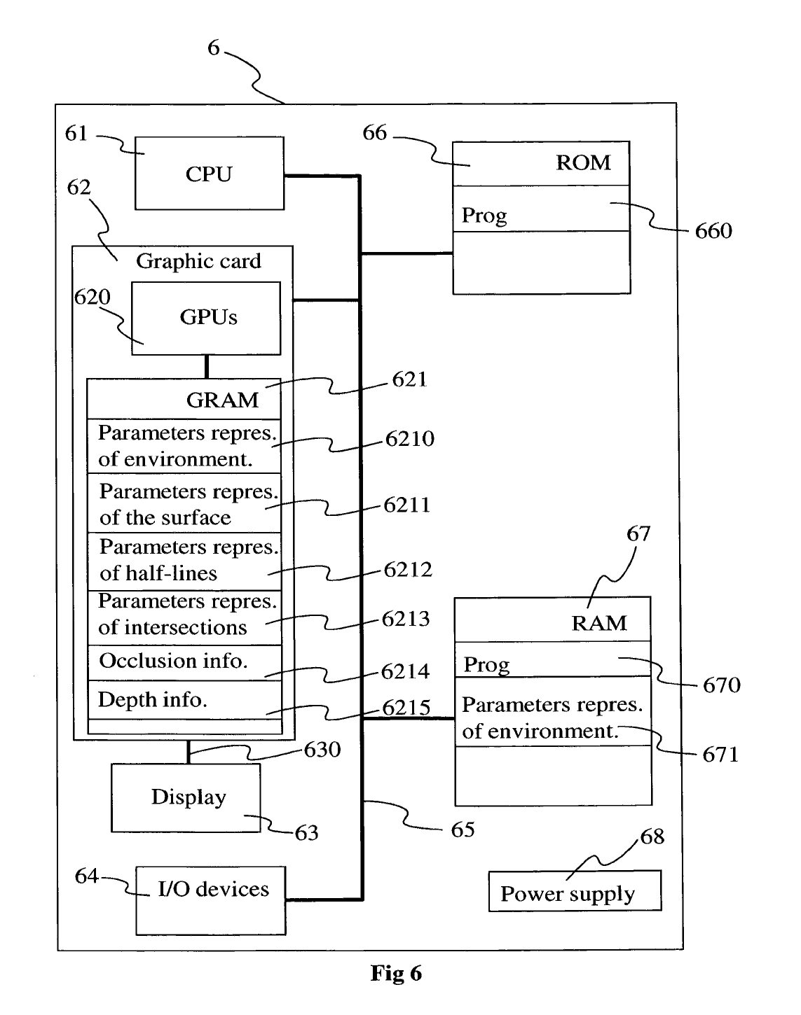

FIG. 6 diagrammatically shows a hardware embodiment of a device 6 adapted for the estimation of the occlusion at a point of a virtual environment 1 and of the creation of display signals of one or several images. The device 6 corresponding for example to a personal computer PC, a laptop or a games console.

The device 6 comprises the following elements, connected to each other by a bus 65 of addresses and data that also transports a clock signal:
a microprocessor 61 (or CPU),
a graphics card 62 comprising:
   several Graphicole Processor Units (or GPUs) 620,
   a Graphical Random Access Memory (GRAM) 621,
a non-volatile memory of ROM (Read Only Memory) type 66,
a Random Access Memory or RAM 67,
one or several I/O (Input/Output) devices 64 such as for example a keyboard, a mouse, a webcam, and
a power source 68.

The device 6 also comprises a display device 63 of display screen type directly connected to the graphics card 62 to display notably the displaying of synthesized images calculated and composed in the graphics card, for example live. The use of a dedicated bus to connect the display device 63 to the graphics card 62 offers the advantage of having much greater data transmission bitrates and thus reducing the latency time for the displaying of images composed by the graphics card. According to a variant, a display device is external to the device 6 and is connected to the device 6 by a cable transmitting the display signals. The device 6, for example the graphics card 62, comprises a means for transmission or connection (not shown in FIG. 4) adapted to transmit a display signal to an external display means such as for example an LCD or plasma screen or a video-projector.

It is noted that the word “register” used in the description of memories 62, 66 and 67 designates in each of the memories mentioned, both a memory zone of low capacity (some binary data) as well as a memory zone of large capacity (enabling a whole program to be stored or all or part of the data representative of data calculated or to be displayed).

When switched-on, the microprocessor 61 loads and executes the instructions of the program contained in the RAM 67.

The random access memory 67 notably comprises:
in a register 630, the operating program of the microprocessor 61 responsible for switching on the device 6,
parameters 671 representative of the virtual environment 1 (for example modelling parameters of the virtual environment 1, lighting parameters of the virtual environment 1).

The algorithms implementing the steps of the method specific to the invention and described hereafter are stored in the memory GRAM 67 of the graphics card 62 associated with the device 6 implementing these steps. When switched on and once the parameters 670 representative of the environment are loaded into the RAM 67, the graphic processors 620 of the graphics card 62 load these parameters into the GRAM 621 and execute the instructions of these algorithms in the form of microprograms of “shader” type using HLSL (High Level Shader Language) language or GLSL (OpenGL Shading Language) for example.

The random access memory GRAM 621 notably comprises:
in a register 6210, the parameters representative of the virtual environment 1,
parameters 6211 representative of the surface S of points of the virtual environment 1 visible from a viewpoint 11 (for example the coordinates of points in the world space),
parameters 6212 representative of half-lines for which are determined the intersection with the surface S (for example the origin, the direction, dicretization parameters),
information 6213 representative of intersections between the half-lines and the surface S (for example the coordinates of intersections, the occlusion distances Δ₀, the distances δⱼ), and
one or several items of occlusion information 6214 representative of the occlusion at one or several visible points of the virtual environment 1,
items of depth information 6215 representative of distances between the viewpoint 11 and the points of the virtual environment 1 visible from the viewpoint 11 (for example values representative of distances separating the viewpoint from visible points).

According to a variant, a part of the RAM 67 is assigned by the CPU 61 for storage of the values 6211 to 6214 and the parameters 6215 if the memory storage space available in GRAM 621 is insufficient. This variant however causes greater latency time in the composition of an image comprising a representation of the environment 1 composed from microprograms contained in the GPUs as the data must be transmitted from the graphics card to the random access memory 67 passing by the bus 65 for which the transmission capacities are generally inferior to those available in the graphics card for transmission of data from the GPUs to the GRAM and vice-versa.

According to another variant, the power supply 68 is external to the device 4.

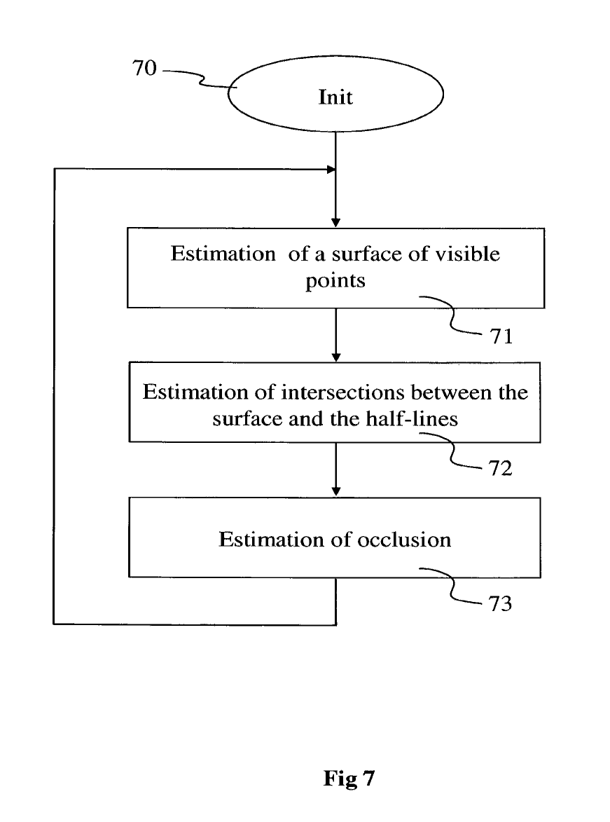

FIG. 7 shows a method for estimation of the occlusion in a point P of a virtual environment implemented in a device 6, according to a non-restrictive particularly advantageous embodiment of the invention.

During an initialisation step 70, the different parameters of the device 6 are updated. In particular, the parameters representative of the virtual environment 1 are initialised in any way.

Then, during a step 71, a surface S grouping all or some of the points of the virtual environment 1 visible from the viewpoint 11 is estimated, this surface comprising the point P in which the occlusion is estimated. The surface S is advantageously estimated in the world space of the virtual environment 1. According to a variant, the surface S is determined in the space of a depth map representative of distances separating the viewpoint 11 from all or some of the points of the virtual environment visible from the viewpoint 11.

Then, during a step 72, the intersections between on one hand each half-line of a plurality of half-lines having as origin the point P and the surface S on the other hand are estimated. To do this, each half-line is discretized in a way to form segments of lines of variable size, the size of each segment being configured by the user. The bigger the size of the segments, the more the calculations for the estimation of the intersection will be rapid to the detriment of the precision of the estimation of the intersection. Conversely, the smaller the size of the segments, the more the estimation of the intersection will be precise and the more the calculations required for the estimation of the intersection will be costly. Advantageously the intersections are estimated in the world space of the virtual environment 1.

According to a variant, the intersections are estimated in the space of the depth map.

According to another variant, the plurality of half-lines for which are estimated the intersections with the surface S form a half-sphere 20 centred on the point P, this half-sphere rising mainly above the surface element associated with the point P.

According to another variant, the half-sphere 30 centred on P and formed of half-lines for which the intersection with the surface S is estimated is tangent to the surface element associated with the point P.

According to a particularly advantageous variant, the direction of half-lines forming a half-sphere centred on P depends on the location of the point P, that is to say depends of the coordinates of the point P, whether these coordinates are represented in the world space or in the space of the depth map. According to this variant, a plurality of half-lines is defined for a first point P of the surface S, the intersection of each of these half-lines with the surface S being determined. For a second point P neighbouring the first point, the half-lines defined are advantageously in a way to have different directions of half-lines associated with the first point P. The same reasoning is applied for each of the points of the surface S neighbouring the point P. Thus, when the neighbouring area of the first point P is considered, a great number of half-lines having different directions is obtained, Which advantageously enables the noise to be reduced which can be generated during the occlusion estimation at the point P with a restricted number of half-lines if all the half-lines associated with the first point P and with the points neighbouring the point P have the same directions.

According to a last variant, the half-lines 40 are discretized using the ray marching method to determine the intersection of each of them with the surface S.

Finally, during a step 73, the occlusion at the point P is estimated from information representative of intersections of half-lines having as origin the point P and the surface S. The occlusion at the point P corresponds advantageously with the ratio of the number of half-lines for which an intersection with the surface S has been found to the number of half-lines for which an intersection with the surface S were sought. According to a variant, the half-lines for which an intersection with the surface S were sought form a sphere or advantageously a half-sphere, a surface element of the sphere or the half-sphere being associated with each half-line. According to this variant, the occlusion at the point P corresponds to the ratio between the sum of surface elements associated with the half-lines having an intersection with the surface S over the total surface of the sphere or the half-sphere respectively. According to another variant, the numerator of the ratio representative of the occlusion at the point P is weighted by each of the occlusion factors associated respectively with each half-line having an intersection with the surface S in a way to take into account the distance between the point P and the intersection with the surface S for the half-lines having an intersection, the occlusion associated with a half-line being greater as the distance to the intersection is short.

According to another variant, the occlusion information at the point P is stored in an occlusion map. In the case where the ambient occlusion of the virtual environment 1 is estimated, the occlusion in each of the points of the virtual environment 1 visible from the viewpoint 11 is estimated by reiterating steps 72 and 73 for each of the visible points, the occlusion information of each of the visible points being stored in the occlusion map. Likewise, when the viewpoint varies, steps 71 to 73 are reiterated to estimate the occlusion in one or several visible points from this new viewpoint.

Naturally, the invention is not limited to the embodiments previously described.

In particular, the invention is not limited to a method for estimation of the occlusion at a point P of the virtual environment but also extends to any device implementing this method and notably any devices comprising at least one GPU. The implementation of calculations necessary to the estimation of the occlusion at the point P is not limited either to an implementation in shader type microprograms but also extends to an implementation in any program type, for example programs that can be executed by a CPU type microprocessor.

The use of the invention is not limited to a live utilisation but also extends to any other utilisation, for example for processing known as postproduction processing in a recording studio for the display of synthesis images for example. The implementation of the invention in postproduction offers the advantage of providing an excellent visual display in terms of realism notably while reducing the required calculation time.

The invention also relates to a method for composition of a video image, in two dimensions or in three dimensions, for which the ambient occlusion according to one or several observation directions is calculated and the information representative of the ambient occlusion that results is used for the displaying of pixels of the image, each pixel corresponding to an observation direction. The ambient occlusion calculated for displaying by each of the pixels of the image is re-calculated to adapt to the different viewpoints of the spectator.

The invention also relates to a method for estimation of the quantity of light received at a point P taking into account the reflections of the light on objects of the virtual environment 1. The quantity of light reflected depends on the occlusion at the point P considered and reflectance properties associated with the elements of the surface associated with the area neighbouring the point P considered.

The present invention can be used in video game applications for example, whether via programs that can be executed in a PC or portable type computer or in specialised game consoles producing and displaying images live. The device 6 described with respect to FIG. 6 is advantageously equipped with interaction means such as a keyboard and/or joystick, other modes for introduction of commands such as for example vocal recognition being also possible.

1. Method for estimation of the occlusion at a point P of a virtual environment, the point P belonging to a surface grouping at least some of the points of the virtual environment visible from a viewpoint, wherein said method comprises the following steps for:
estimating of information representative of intersections between said surface and a plurality of half-lines having as origin said point P, said intersections being estimated by discretization of each half-line of said plurality of half-lines,
associating of occlusion factors with the half-lines of said plurality of half-lines having an intersection with said surface, said occlusion factors being a function of occlusion distances Δ₀ separating said point P from said intersections, and
estimating of occlusion at said point P from said information representative of intersections estimated and said occlusion factors.

2. Method according to claim 1, wherein the value of an occlusion factor associated with a half-line of said plurality is inversely proportional to the distance separating said point P from the intersection between said half-line and said surface.

3. Method according to claim 1, wherein the occlusion at said point P corresponds to the ratio of the number of half-lines having an intersection with said surface to the total number of the plurality of half-lines, the numerator of said ratio representative of the occlusion at the point P being weighted with said occlusion factors.

4. Method according to claim 1, wherein it comprises in addition a step of estimation of distances separating said viewpoint from visible points of the virtual environment, said estimated distances being represented in a depth map, the estimation of said items of information representative of intersections being carried out in the space of the depth map.

5. Method according to claim 1, wherein the plurality of half-lines form a half-sphere centred on the point P and rising mainly over a surface element of said surface associated with the point P.

6. Method according to claim 5, wherein the base of said half-life is tangent to said surface element associated with the point P.

7. Method according to claim 1, wherein it comprises a step of storage of an item of information representative of the occlusion at the point P in an occlusion map.

8. Method according to claim 1, wherein the direction (ωᵢ) of half-lines depends on the location of the point P.

9. Method according to claim 1, wherein said information representative of intersections is estimated using the ray marching method.

10. Device adapted for the estimation of the occlusion at a point P of a virtual environment, the point P belonging to a surface grouping at least some of the points of the virtual environment visible from a viewpoint, wherein said device comprises:
means for the estimation of information representative of intersections between said surface and a plurality of half-lines having as origin said point P, said intersections being estimated by discretization of each half-line of said plurality of half-lines, and
means for the association of occlusion factors with the half-lines of said plurality of half-lines having an intersection with said surface, said occlusion factors being a function of occlusion distances Δ₀ separating said point P from said intersections, and
means for the estimation of occlusion at said point P from said information representative of intersections estimated and said occlusion factors.

11. Device according to claim 10, wherein the value of an occlusion factor associated with a half-line of said plurality is inversely proportional to the distance separating said point P from the intersection between said half-line and said surface.

12. Device according to claim 10, wherein the occlusion in said point P corresponds to the ratio of the number of half-lines having an intersection with said surface to the total number of the plurality of half-lines, the numerator of said ratio representative of the occlusion at the point P being weighted with said occlusion factors.
